(19) United States
(12) Patent Application Publication
(10) Pub. No.: US 2024/0208545 A1
(43) Pub. Date: Jun. 27, 2024

(54) DEVICE, SYSTEM AND METHOD FOR IDENTIFYING OBJECTS IN THE SURROUNDINGS OF AN AUTOMATED DRIVING SYSTEM

(71) Applicant: ZF Friedrichshafen AG, Friedrichshafen (DE)

(72) Inventors: Martin RUCHTI, Langenargen (DE); Robert MÄRTIN, Wasserburg (DE)

(73) Assignee: ZF Friedrichshafen AG, Friedrichshafen (DE)

(21) Appl. No.: 17/913,767

(22) PCT Filed: Mar. 10, 2021
(86) PCT No.: PCT/EP2021/055999

§ 371 Date: Sep. 22, 2022

(30) Foreign Application Priority Data
Mar. 24, 2020 (DE) 10 2020 203 745.0

(51) Int. Cl. B60W 60/00; G06T 7/292; G06V 10/776; G06V 20/58

(52) U.S. Cl. CPC B60W 60/0027; G06T 7/292; G06V 10/776; G06V 20/58; B60W 2420/403; B60W 2420/408; B60W 2420/54; G06T 2207/20081; G06T 2207/20084; G06T 2207/30252

(57) ABSTRACT

A device for identifying objects in an automated driving system's environment, comprising a first evaluation unit for identifying objects and forming object hypotheses, and a second evaluation unit for verifying and/or rejecting the object hypotheses and/or false positive objects. Also disclosed are a system and a method for identifying objects in an automated driving system's environment.

The invention relates to a device, system and method for identifying objects in the environment of an automated driving system.

A high degree of reliability is demanded of driver assistance systems, autonomous driving functions and driving systems with regard to error. Certain false negative and false positive results will result in critical errors in environment detection and also lead to critical errors in the driving functions.

DE 10 2016 012 345 A1 discloses a method for identifying objects in a vehicle's environment in which hypotheses regarding an object are obtained from camera data, and false positives are eliminated using a lidar sensor.

The object of the invention is to create a sensor system for reliable environment detection that is optimized with regard to eliminating false positive and false negative results.

The invention achieves this object by separating the functions into object identification, hypothesis formation, and subsequent hypothesis confirmation. In concrete terms, an object recognition stage in which relevant object properties are identified, e.g. size, classification, speed, position, is paired with a downstream hypothesis confirmation stage in which object properties are not estimated or evaluated, but only checked to determine whether an object actually exists. According to one aspect of the invention, estimated object properties are also drawn on for the existence confirmation.

According to one aspect, the invention results in a device for identifying an object in a vehicle's environment. The device comprises a first evaluation unit. The first evaluation unit comprises first input interfaces for first environment detection sensors in the automated driving system with which first signals of the first environment detection sensors are obtained. The first evaluation unit also comprises at least one first computer unit, which executes first machine commands for identifying the object and forming object hypotheses, and the identification and/or formation of object hypotheses takes place separately for each of the first environment detection sensors or each combination of first environment detection sensors in order to minimize the frequency of false negatives. Furthermore, the first evaluation unit comprises a first output interface to which a first list is provided that comprises the objects, object hypotheses, and false positive objects. The device also comprises a second evaluation unit. The second evaluation unit comprises second input interfaces for second environment detection sensors in the automated driving system with which second signals are obtained from the second environment detection sensors. The second evaluation unit also comprises at least one second computer unit, which executes second machine commands with which the object hypotheses are verified and/or false positive objects are eliminated on the basis of the second signals and the first lists. The second evaluation unit also comprises a second output interface with which a second list is obtained, comprising results of the second computer unit.

By separating the functions of object identification and existence verification, i.e. by using the first evaluation unit for object identification and the second evaluation unit for existence verification, highly specialized systems or subsystems can be obtained, i.e. the first evaluation unit and second evaluation unit, which are optimized for their specific tasks. It is therefore not necessary to use “one system for everything,” in which optimization with regard to conflicting objectives would be necessary. This results in a better, modular and more economical embodiment.

The object of the invention is inherently modular and can be expanded because additional methods for identification or hypothesis confirmation can be incorporated in both the object identification stage, i.e. in the first evaluation unit, as well as the hypothesis confirmation stage, i.e. in the second evaluation unit, without having to discard existing components. According to one aspect of the invention, these various methods are combined in the first, and in particular in the second, evaluation units to form ensembles, e.g. cascades or committees.

The second stage of the device, i.e. the second evaluation unit, ultimately generates an object list or the like, which is optimized for eliminating false positives, specifically with the second evaluation unit, and false negatives, specifically with the first evaluation unit. The second stage is designed to refute identification of objects that do not really exist.

The first environment detection sensors are extremely sensitive in order to ensure that they are reliable with regard to false negatives. The second environment detection sensors are optimized with regard to confirming hypotheses. The objective of the second environment detection sensors is to eliminate objects identified by the first evaluation unit if they are false positives. The first and second environment detection sensors comprise cameras, radars, lidars, ultrasonic sensors, microphones, time-of-flight sensors and laser photo sensors. In theory, the sensor technologies used for the first environment detection sensors can also be used for the second environment detection sensors, and vice versa. Another aspect of the invention comprises a sensor system that actively modifies its own inputs in order to be able to check hypotheses, e.g. using actively moved (cascading) cameras or actively oriented lidars.

The device is a sensor signal processing module, for example, which contains input interfaces for receiving signals from the environment detection sensors, evaluation units that evaluate the signals, and output interfaces that output the evaluated signals, e.g. in the form of regulating and/or control signals, to actuators in the vehicle, e.g. for automated/autonomous longitudinal and/or lateral guidance. Longitudinal guidance is regulated, for example, by regulating the drive torque, e.g. by controlling the electronic motor output, and/or regulating braking torque. Lateral guidance regulates the lateral dynamics of the vehicle, e.g. through lane-keeping assistance and/or directional assistance, as well as steering maneuvers and/or yaw velocity control.

The invention is not limited to automated or autonomous vehicles. The scope application for the invention extends to automated driving systems. Automated driving systems comprise all automated and autonomous systems with which uncertainty of perception must be taken into account, and in which erroneous and false perceptions must be prevented. In addition to the vehicles described herein, automated driving systems also relate to service robots, drones, and robots on legs.

Vehicles that can be driven in an automated manner, e.g. with an internal combustion engine, or electric drive, or hybrid electric vehicles or fuel cell vehicles, preferably road vehicles using one of these drive technologies, are equipped such that they can assume the duties of a driver. According to one aspect, the invention is used for driving functions in the SAE J3016 stages from level 2 to level 5. By way of example, the device is an ADAS/AD-domain ECU, i.e. an electronic control unit for the domain, “advanced driver assistance system/autonomous driving.”

Objects in an automated driving system's environment comprise other driving systems, vehicles, bicycles, pedestrians, and other road users. The environment comprises the space surrounding the automated driving system in which a trajectory or predicted trajectory may be affected.

The evaluation units comprise programmable electronic circuits that comprise logic units.

The computer units execute machine commands from a computer program. The computer units comprise arithmetical logic units, central processing units, graphics processors, multi-core processors, ICs, ASICs, FPGAs and other logical and/or programmable microelectronic systems. The evaluation units comprise internal and/or external memories according to one aspect of the invention, which store the machine commands, and a bus system for data exchange with the computer units and peripheral devices. By way of example, the memory is a double data rate synchronous dynamic random access memory, or DDR SDRAM. The memory is preferably a low power DDR SDRAM.

The first machine commands comprise, by way of example, commands for executing a machine learning algorithm. The first computer unit is optimized for executing machine learning algorithms, for example. The first computer unit comprises a graphics processor with a microarchitecture for parallel processing and/or hardware acceleration for machine learning, for example. Machine learning is a technology that teaches computers and other data processing devices how to execute tasks by learning from data instead of having to be programmed for the tasks. The machine learning algorithm is a convolutional neural network that is trained in semantic image recognition. This enables further minimization of false negatives. With regard to tracking objects, the convolutional neural network is advantageously a recurrent convolutional neural network, i.e. a convolutional neural network with recurrent layers, e.g. LSTM units, i.e. Long Short Term Memory units.

The second machine commands comprise commands for executing a deterministic algorithm according to one aspect of the invention. This algorithm is robust and can preferably be interpreted by a human being. By way of example, this algorithm implements methods from the field of multi-camera geometry to refute object hypotheses. By way of example, these geometry-based approaches are supported by geometrical recognition using lidar or structured light.

Object hypotheses comprise conjectures regarding the probability of a certain object being in a region within the range of the environment detection sensors.

The fact that for each of the first environment detection sensors the identification and/or formation of object hypotheses takes place separately means that the first signals are not subjected to a fusion. This differs from the prior art relating to known object identification methods in which sensor signals are combined for purposes of redundancy and plausibility. Instead, a voting takes place with the subject matter of the invention. The voting, or a modified ensemble method, takes place via object hypotheses based on individual sensors and sensor fusion. With n sensors, n individual sensors can be drawn on. For every k fusions, where k≤n via the n sensors, n/k hypotheses can theoretically be formed. The following example is only formulated for individual sensors, but can of course be expanded by arbitrary pairs of fusions, e.g. k=2, i.e. camera+lidar. By way of example, the first environment detection sensors comprise a camera, a lidar, and a radar. In one scenario, the radar detects an object. The camera and lidar do not detect an object. With a fusion of the camera, lidar and radar data, no object is output. This could result in a false negative, however, if there actually were an object. With the invention, an object is output, even if it is only detected by one environment detection sensor. This minimizes the frequency of false negatives. According to one aspect of the invention, the first evaluation unit also outputs an object in the first list, even if relatively few pixels from a camera, lidar or radar sensor provide a signal. This results in a reliable threshold, further reducing the false negative frequency. If the object does not actually exist, this increases the number of false positive objects. This problem is then resolved by the second evaluation unit.

False positives and false negatives relate to existence uncertainties, i.e. the uncertainty of whether an object detected by the environment detection sensors and object included in the representation of the environment actually exists. With false positives, an object is identified even though it does not actually exist. By way of example, a shadow cast onto a roadway may be identified as a tire. With false negatives, an object that actually exists is not detected.

The second list is optimized for false positives, specifically by the evaluation by the second evaluation unit, and for false negatives, specifically by the evaluation by the first evaluation unit. The second stage cannot falsely refute the presence of an object, because this would also result in a false negative.

According to another aspect, the invention results in a system for identifying objects in an automated driving system's environment. The system comprises first and second environment detection sensors and a device according to the invention. The first environment detection sensors are connected for signal transfer to a first evaluation unit in the device, and the second environment detection sensors are connected for signal transfer to a second evaluation unit in the device. The device is designed to determine regulating and/or control signals on the basis of the results from a second computer unit in the device, and supply the regulating and/or control signals to actuators in the automated driving system for longitudinal and/or lateral guidance.

The first evaluation unit, first environment detection sensors, and first computer unit form a first subsystem. The second evaluation unit, second environment detection sensors, and second computer unit form a second subsystem. Depending on the design of the system, if an object existence hypothesis is determined to be false, the hypothesis and/or object are discarded directly in the second subsystem. If the first subsystem contains a multi-hypothesis object tracking stage, this stage is instructed to discard this hypothesis.

According to one aspect of the invention, various topologies of the first and second subsystems are linked in parallel or in series. Furthermore, the first environment detection sensors and the analysis logic of the second subsystem can be integrated. Moreover, the second subsystem can be coupled back to a multi-hypothesis stage for object hypothesis formation and/or object tracking in the first subsystem, and in particular, the second evaluation unit is coupled back to the first evaluation unit.

According to another aspect of the invention, there is a method for identifying objects in an automated driving system's environment. The method comprises the following steps:
Identifying properties of the object
Forming object hypotheses, and
Verifying the identified objects and object hypotheses.

A device according to the invention, or a system according to the invention is used for executing the method.

The method is implemented by a computer according to one aspect of the invention. This means that the steps of the method are executed by a data processing device, e.g. a computer, computing system, or parts thereof.

Further embodiments of the invention can be derived from the dependent claims, drawings, and the descriptions of preferred exemplary embodiments.

In one embodiment of the invention, the first computer unit tracks the object by executing the first machine command, the first evaluation unit then includes the tracking in the first list, and the second evaluation unit evaluates the tracking. By way of example, the machine commands comprise commands for executing a tracking algorithm. Tracking makes it possible estimate the probability of the existence of a specific object in an integrated manner.

In another embodiment of the invention, the first computer unit forms multiple hypotheses for identifying and/or tracking the object by executing the first machine command, the first evaluation unit includes the multiple hypotheses in the first list, and the second evaluation unit evaluates the multiple hypotheses. Alternative hypotheses are then also evaluated according to the invention, and the number thereof is reduced in a non-aggressive manner. This further reduces the number of false negatives.

In another embodiment of the invention, the identification of the objects takes place in cycles, and the second evaluation unit verifies and/or rejects the object hypotheses and/or false positive objects numerous times in each cycle of the first evaluation unit. This results in high level of reliability regarding false positives at the sensor level. The identification of objects takes place, by way of example, at 40 Hz cycles for the first environment detection sensors. The second environment detection sensors have a higher cycle-speed or rate. By way of example, tens to hundreds of verifications of object hypotheses take place for each object identification cycle, e.g. using a beam sensor in the second environment detection sensors, e.g. a lidar. This is achieved, for example, through the control of the beams of the beam sensor.

In another embodiment of the invention, the second evaluation unit is designed to verify the object hypotheses and/or reject false positive objects by means of three dimensional structure estimation and/or geometrical consistence based on the fields of vision of the second and/or first environment detection sensors. This results in a high level of reliability regarding false positives at the level of the second evaluation unit as well, as an alternative or in addition to the sensor level. Three dimensional structure estimation is obtained, for example, using time-of-flight sensors. This makes it possible to determine spatial volumes.

In another embodiment of the invention, the device comprises a third evaluation unit. The third evaluation unit executes third machine commands that determine a potential danger for each of the objects, the object hypotheses and/or the false positive objects in the first list. Based on this danger, the objects, object hypotheses and/or false positive objects are prioritized by executing the third machine commands, and a prioritized first list is sent to the second evaluation unit, containing the prioritized objects, object hypotheses, and/or false positive objects. The second evaluation unit verifies and/or rejects these on the basis of the prioritization of the object hypotheses and/or false positive objects. The third evaluation unit determines a hierarchy for the verification sequence of the contents of the first list from the evaluation unit by the second evaluation unit.

In another embodiment of the invention, the first and/or second environment detection sensors function in multiple wavelength ranges. This serves to compensate for shortcomings in perception. By way of example, lidar sensors in the second environment detection sensors function in two different lidar wavelength spectra. This makes it possible to penetrate fog.

In another embodiment, virtual false positive objects are included in the first object stage. The efficiency of the rejection rate can be continuously checked on the basis of the rate at which the virtual objects are eliminated.

The invention shall be explained in greater detail below on the basis of exemplary embodiments. In the drawings:

FIG. 1 shows an example of an environment,

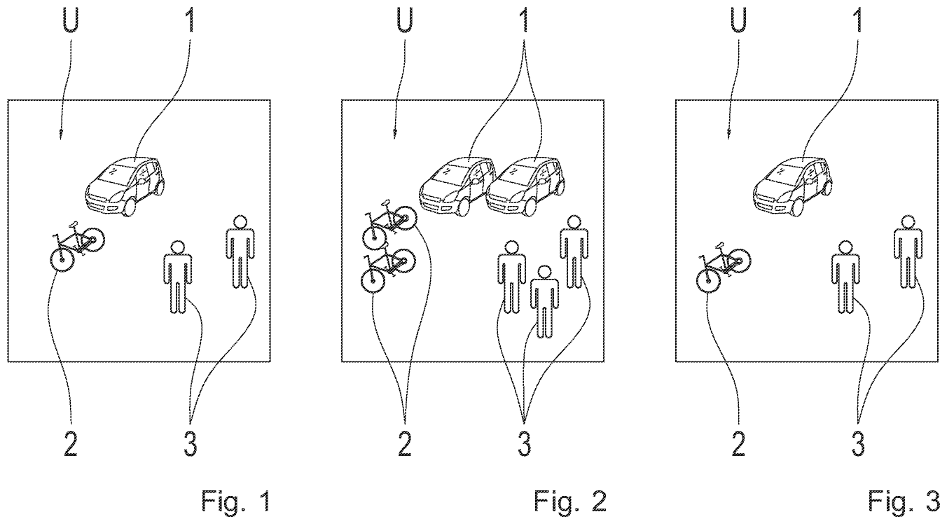

FIG. 2 shows a first image of the environment shown in FIG. 1 created by the first evaluation unit according to the invention,

FIG. 3 shows a second image of the first image shown in FIG. 2, created by the second evaluation unit according to the invention,

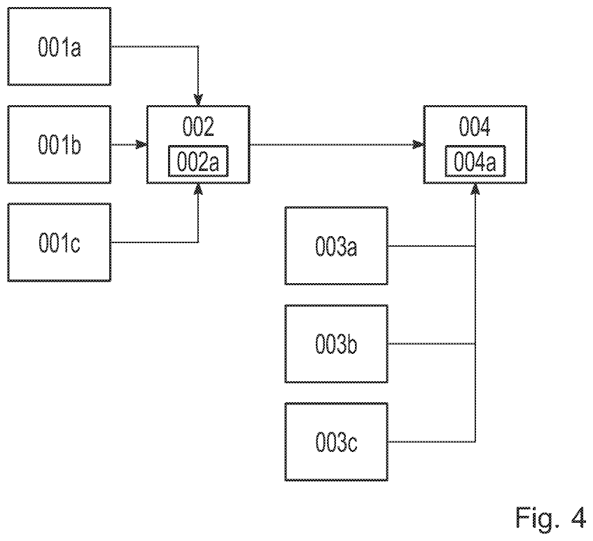

FIG. 4 shows an exemplary embodiment of the device according to the invention,

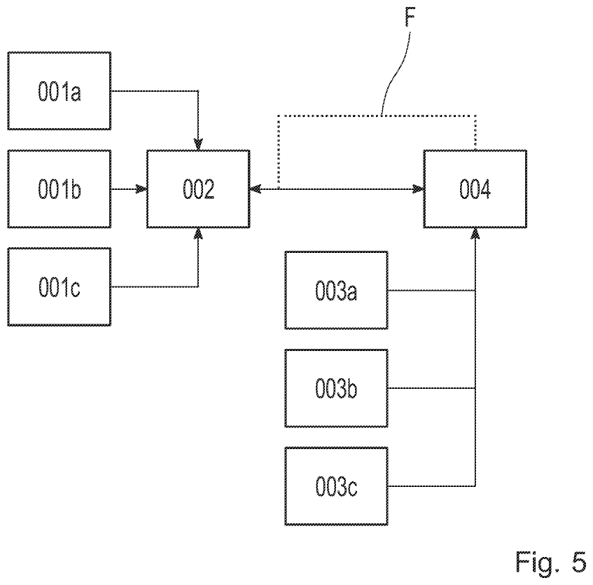

FIG. 5 shows another exemplary embodiment of the device according to the invention,

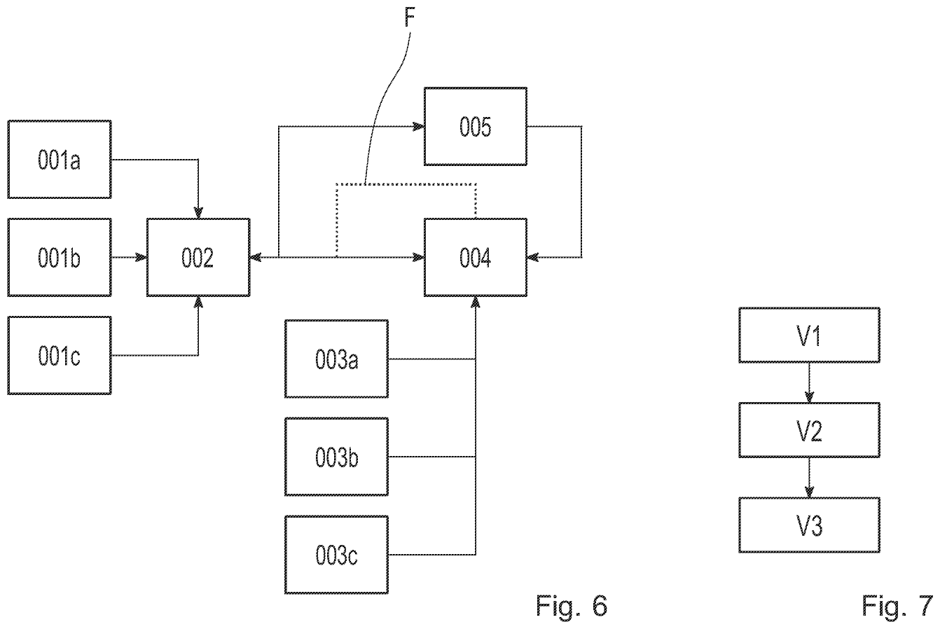

FIG. 6 shows another exemplary embodiment of the device according to the invention, and

FIG. 7 shows a schematic illustration of the method according to the invention.

The same reference symbols are used for identical or functionally similar elements in the drawings. For purposes of clarity, only the relevant elements are indicated with reference symbols in the individual drawings.

FIG. 1 shows a vehicle's environment U as it actually exists. The environment U comprises numerous objects 1, 2, 3, e.g. a vehicle 1, bicycle 2, and two pedestrians.

FIG. 2 shows a first image of the environment U from a first evaluation unit 002. This first image is provided by way of example by the first evaluation unit 002 via the first output interface as the first list. The first image comprises objects 1, 2, 3 in the environment and is therefore reliable with regard to false negatives. The first image also comprises object hypotheses, e.g. an additional vehicle, additional bicycle, and additional pedestrian.

FIG. 3 shows a second image of the first image. This second image is provided by way of example by the second evaluation unit 004 via the second output interface as the second list. The second image comprises objects 1, 2, 3 in the environment. The false positives in the first image have been eliminated.

The device in FIG. 4 comprises the first evaluation unit 002. The first evaluation unit 002 is connected for signal transfer to the first environment detection sensors 001a, 001b, 001c. The first environment detection sensor 001a is a camera, by way of example. The first environment detection sensor 001b is a lidar, by way of example. The first environment detection sensor 001c is a radar, by way of example. The first evaluation unit 002 comprises a first computer unit 002a. The first computer unit 002a generates a first list containing objects 1, 2, 3 identified by the first environment detection sensors 001a, 001b, 001c, object hypotheses and false positive objects.

The first list is sent to the second evaluation unit 004. The second evaluation unit 004 is connected for signal transfer to second environment detection sensors 003a, 003b, 003c. The second environment detection sensor 003a is a camera, by way of example. The second environment detection sensor 003b is a lidar, by way of example. The second environment detection sensor 003c is a radar, by way of example. The second evaluation unit 004 comprises a second computer unit 004a. The second computer unit 004a generates a list based on the first list and the evaluated signals from the second environment detection sensors 003a, 003b, 003c. The second list is reliable with regard to false positives and false negatives.

FIG. 5 substantially shows the exemplary embodiment shown in FIG. 4. The difference to FIG. 4 is that the second evaluation unit 004 is coupled back to the first evaluation unit 002. The return coupling forms a feedback path for forming multi-object hypotheses and/or tracking by the first evaluation unit 002.

FIG. 6 shows the exemplary embodiment shown in FIG. 5 with an additional, third evaluation unit 005. The third evaluation unit 005 determines a hierarchy on the basis of the potential danger to the objects 1, 2, 3 for the sequence of checking the first list from the first evaluation unit 002 by the second evaluation unit 004. By way of example, pedestrians are prioritized over bicycles, and bicycles have a higher priority than vehicles.

FIG. 7 shows the method according to the invention. In step V1, properties of the objects 1, 2, 3 are identified, e.g. speed and whether the object is a vehicle, pedestrian, or bicycle. Object hypotheses are formed in step V2 to minimize the frequency of false negatives. The identified objects 1, 2, 3 and object hypotheses are verified in step V3. The device according to the invention is used for executing the method, for example. The object identification and formation of hypotheses takes place in the first evaluation unit 002. The verification takes place in the second evaluation unit 004.

### LIST OF REFERENCE SYMBOLS

1 object
2 object
3 object
U environment
001a first environment detection sensor
001b first environment detection sensor
001c first environment detection sensor
002 first evaluation unit
002a first computer unit
003a second environment detection sensor
003b second environment detection sensor
003c second environment detection sensor
004 second evaluation unit
004a second computer unit
005 third evaluation unit
F feedback connection
V1-V3 steps of the method

1. A device for identifying objects in an automated driving system's environment, comprising:
a first evaluation unit (002), comprising:
first input interfaces for first environment detection sensors in the automated driving system configured to obtain first signals from the first environment detection sensors;
at least one first computer unit configured to execute first machine commands to identify the objects and to form object hypotheses, wherein the identification and/or formation of object hypotheses takes place separately for each of the first environment detection sensors or for each combination of the first environment detection sensors to minimize a frequency of false negatives; and
a first output interface configured to provide a list comprising the objects, object hypotheses, and false positive objects; and
a second evaluation unit comprising:
second input interfaces for second environment detection sensors in the automated driving system configured to obtain second signals from the second environment detection sensors;
at least one second computer unit configured to execute second machine commands to verify the object hypotheses and/or to reject false positive objects on a basis of the second signals and the first list; and
a second output interface configured to provide a second list comprising results of the second computer unit.

2. The device according to claim 1, wherein:
the first computer unit is configured to execute the first machine commands to track the objects,
the first evaluation unit is configured to place tracking results in the first list, and
the second evaluation unit is configured to evaluate the tracking results.

3. The device according to claim 1, wherein:
the first computer unit is configured to execute the first machine commands to form multiple hypotheses for identifying and/or tracking the objects,
the first evaluation unit is configured to place the multiple hypotheses in the first list, and
the second evaluation unit is configured to evaluate the multiple hypotheses.

4. The device according to claim 1, wherein the at least one first computer unit is configured to identify the objects in cycles, and
wherein the second evaluation unit is configured to verify the object hypotheses and/or reject false positive objects numerous times in each cycle of the first evaluation unit.

5. The device according to claim 1, wherein the second evaluation unit is configured to verify the object hypotheses and/or reject false positive objects using three dimensional structure estimation and/or geometrical consistence on a basis of fields of vision of the various second environment detection sensors and/or the first environment detection sensors.

6. The device according to claim 1, comprising:
a third evaluation unit configured to execute third machine commands to determine a danger for the objects, the object hypotheses, and/or the false positive objects in the first list;
prioritize the objects, object hypotheses, and/or false positive objects on a basis of the danger; and
provide a prioritized first list to the second evaluation unit of the prioritized objects, object hypotheses, and/or false positive objects,
wherein the second evaluation unit is configured to verify the object hypotheses and/or reject the false positive objects on a basis of the prioritization.

7. The device according to claim 1, wherein the first environment detection sensors and/or the second environment detection sensors function in numerous wavelength ranges.

8. A system for identifying objects in an automated driving system's environment, comprising:
the first environment detection sensors and the second environment detection sensors; and
the device according to claim 1,
wherein the first environment detection sensors are each connected for signal transfer to the first evaluation unit and the second environment detection sensors are each connected for signal transfer to the second evaluation unit, and
wherein the device is configured to:
determine regulating and/or control signals on a basis of the results of the second computer unit, and
send the regulating and/or control signals to actuators in the automated driving system for longitudinal and/or lateral guidance.

9. A method for identifying objects in an automated driving system's environment, the method comprising:
identifying, with a first computer of a first evaluation unit, properties of the objects using first signals from first environment detection sensors;
forming, with the first computer, object hypotheses; and
verifying, with a second computer of a second evaluation unit, the identified objects and object hypotheses using second signals from second environment detection sensors.

10. The method according to claim 9, further comprising:
tracking the objects by the first computer;
placing, by the first evaluation unit, tracking results in a first list; and
evaluating, by the second computer, the tracking results in the first list.

11. The method according to claim 9, further comprising:
forming, by the first computer, multiple hypotheses for identifying and/or tracking the objects;
placing, by the first evaluation unit, the multiple hypotheses in a first list; and
evaluating, by the second computer, the multiple hypotheses in the first list.

12. The method according to claim 9, further comprising:
identifying, by the first computer, objects in cycles; and
verifying, by the second computer, the object hypotheses and/or reject false positive objects numerous times in each cycle.

13. The method according to claim 9, further comprising:
verifying, by the second computer, the object hypotheses and/or reject false positive objects using three dimensional structure estimation and/or geometrical consistence on a basis of fields of vision of the second environment detection sensors and/or the first environment detection sensors.

14. The method according to claim 9, further comprising:
determining, by a third evaluation unit, a danger for the objects, the object hypotheses, and/or false positive objects;
prioritizing, by the third evaluation unit, the objects, the object hypotheses, and/or the false positive objects on a basis of the danger;
providing a prioritized first list to the second evaluation unit of the prioritized objects, object hypotheses, and/or false positive objects; and
verifying, by the second evaluation unit, the object hypotheses and/or reject the false positive objects on a basis of the prioritization.

15. The method according to claim 9, further comprising:
operating the first environment detection sensors and/or the second environment detection sensors in numerous wavelength ranges.

16. The method according to claim 9, further comprising:
operating the first environment detection sensors and/or the second environment detection sensors in numerous wavelength ranges.
